(19) United States
(12) Patent Application Publication
(10) Pub. No.: US 2006/0220612 A1
(43) Pub. Date: Oct. 5, 2006

(54) Modular panel for a power tool

(76) Inventors: William Mark Feldmann, Fairfield, OH (US); Berlie E. Parks, Lawrenceburg, IN (US); Kyle W. Harris, Orchard Park, NY (US)

Correspondence Address: STEPHEN D. SCANLON, JONES DAY, 901 LAKESIDE AVENUE, CLEVELAND, OH, 44114, US

(21) Appl. No.: 11/129,903

(22) Filed: May 16, 2005

Related U.S. Application Data
(63) Continuation-in-part of application No. 29/226,712, filed on Mar. 31, 2005, now Pat. No. D525847.

(51) Int. Cl. H02J 7/00

(52) U.S. Cl. 320/114

(57) ABSTRACT

A power tool includes a main body having an upper surface and a power source. A power level indicator is positioned on the upper surface of the main body of the power tool. In the case of a cordless power tool, a removable battery is the power source and the power level indicator is a battery charge indicator that is electrically coupled to the battery. A modular panel for a power tool is configured to seat in an opening disposed on a power tool. The panel includes a panel member, at least one opening disposed on the panel member for association with an accessory component, and at least one coupling mechanism for coupling the at least one accessory component to the panel. The coupling member is configured to allow coupling of the accessory component to the panel prior to coupling of the panel to the housing of a main body.

### CROSS-REFERENCE TO RELATED APPLICATION

This application is a continuation-in-part of copending U.S. Design Application No. 29/226,712, filed Mar. 31, 2005.

### FIELD

This technology relates to hand-held electric and cordless power tools. More particularly, this technology concerns a modular panel for a power tool.

### BACKGROUND

Power tools customarily utilize speed control switches or buttons. These switches or buttons may be positioned on an upper surface, a side surface, or a lower surface of the power tool. The housing is typically integrally molded to form an opening and the switches or buttons are configured to seat in the openings for access by a user. Accessory components, such as drill bit holders, levels, and other accessory components are also known to be positioned on the body of power tools. The accessory components are often molded into the housing of the tool, or are defined by individual inserts or attachments that are positioned on or through the housing.

Cordless power tools typically utilize a battery pack for power. In some tools, the battery pack is positioned below the handle and body of the tool, such as in a drill. Battery packs often utilize a battery indicator that is typically positioned on the battery pack. The user is required to look under the housing of the drill or towards the bottom of the drill to determine whether the battery pack is charged. Drill user's often utilize more than one battery pack with a single tool to allow for continuous operation of a power tool. Each battery pack has a charge indicator, which adds to the overall cost of the battery pack.

### BRIEF DESCRIPTION OF THE DRAWINGS

FIG. 1 is a perspective view of an example panel on a cordless drill;

FIG. 2 is an exploded perspective view of the example panel depicting the panel and gear control switch exploded from the housing of the cordless drill;

FIG. 3 is an exploded perspective view of an example panel with accessories;

FIG. 4 is a top view of an example panel without accessories being installed;

FIG. 5 is a bottom view of the panel of FIG. 4;

FIG. 6 is a cross-sectional view of the panel of FIG. 4, taken along line 6-6 in FIG. 4;

FIG. 7 is a perspective view of an example panel having accessories coupled to the panel;

FIG. 8 is a top view of the panel of FIG. 7;

FIG. 9 is a left end view of the panel of FIG. 7;

FIG. 10 is a right end view of the panel of FIG. 7;

FIG. 11 is a bottom view of the panel of FIG. 7;

FIG. 12 is a cross-sectional view of the panel of FIG. 7, taken along line 12-12 in FIG. 8;

FIG. 13 is a perspective view of an example panel installed on a cordless drill housing section;

FIG. 14 is a side view of the example panel and drill depicted in FIG. 13;

FIG. 15 is a cross-sectional end view of the example panel and drill depicted in FIG. 13; and

FIG. 16 is a perspective view of a cordless drill housing section.

### DETAILED DESCRIPTION

According to the below described examples, a handheld power tool comprises a main body having an upper surface and including a drive mechanism, a motor, and an output mechanism. A handle portion is coupled to the main body and has a motor activation switch associated therewith. The motor activation switch is coupled to the motor in order to activate the output mechanism. A power level indicator is positioned on the upper surface of the main body.

In one embodiment, the power tool further comprises a battery coupled to the main body and in association with the motor. In this embodiment, the power level indicator is a battery charge indicator that is electrically coupled to the battery. The battery may be removably coupled to the handle portion and the battery indicator may comprise at least one LED.

A panel may be coupled to an opening in the upper surface of the main body. The power level indicator may be coupled to the panel. The panel may be configured to accept at least one accessory selected from the group consisting of a gear control switch, a magnet, a drill bit snap fitting, a level, a tray, and a power level indicator. The magnet may comprise a molded-in magnet and is used for retaining metallic objects. The gear control switch is used to control the speed and torque of the power tool. The power level indicator is for indicating the power level available for use by the power tool and may comprises an illumination mechanism and an activation mechanism.

In order to couple the panel to the main body of the power tool, the panel comprises a plurality of protrusions or lugs and the main body comprises a plurality of recesses. The protrusions and recesses are configured to mate with one another to join the panel to the main body.

The gear control switch may be coupled to the panel and includes first and second side rails. The main body includes first and second ledges that are configured to hold the first and second side rails of the gear control switch. The panel includes an opening through which at least part of the gear control switch is accessible for movement by a user, and the first and second side rails of the gear control switch are sandwiched between the panel and the first and second ledges on the main body to allow sliding, back and forth longitudinal movement of the gear control switch relative to the main body and panel. Each of the first and second side rails may include laterally extending protrusions. The main body may include at least one indentation adjacent each of the first and second ledges for mating with the protrusions. The sliding back and forth movement of the gear control switch results in movement of the protrusions in and out of contact with the at least one indentation to provide at least one of a tactile or audible signal to the user that the gear control switch is associated with a particular gear. The panel is modular in that it is configured to allow coupling of accessories to the panel prior to installation of the panel in the opening on the main body.

In another embodiment, a power tool comprises a main body having an upper surface, a handle portion, a battery coupled to one of the main body or the handle portion, and a battery charge indicator disposed on the upper surface of the main body and electrically coupled to the battery. The battery charge indicator may include an illumination mechanism and an activation mechanism. The battery charge indicator may be disposed on a panel member that is coupled to an upper surface of the power tool.

In yet another embodiment, a modular panel for a power tool is configured to seat in an opening disposed in a power tool and includes a panel member configured to couple to a main body of a power tool, at least one opening disposed on the panel member for association with an accessory component, and at least one coupling mechanism associated with the panel member for coupling an accessory component to the panel member. The coupling mechanism may be configured to allow coupling of the accessory component to the panel member prior to coupling of the panel member with a main body of a power tool. The at least one opening in the panel is provided to allow access to the accessory component by a user, whether physically, visually, or otherwise.

At least one opening in the panel member may comprise a plurality of openings and the at least one accessory component may comprise a plurality of accessory components. The plurality of accessory components may include one or more of a gear control switch, a magnetic tray, a level, and a power level indicator.

In a further embodiment, a method for manufacturing a power tool comprises providing a housing of a power tool, the housing having an opening defined therein, providing a panel member that is configured to couple to the opening in the housing, the panel member having a plurality of openings disposed for association with accessory components and a plurality of coupling mechanisms for coupling the accessory components to the panel member, coupling a plurality of accessory components to the openings in the panel member utilizing the coupling components, and coupling the panel member to the housing of the power tool.

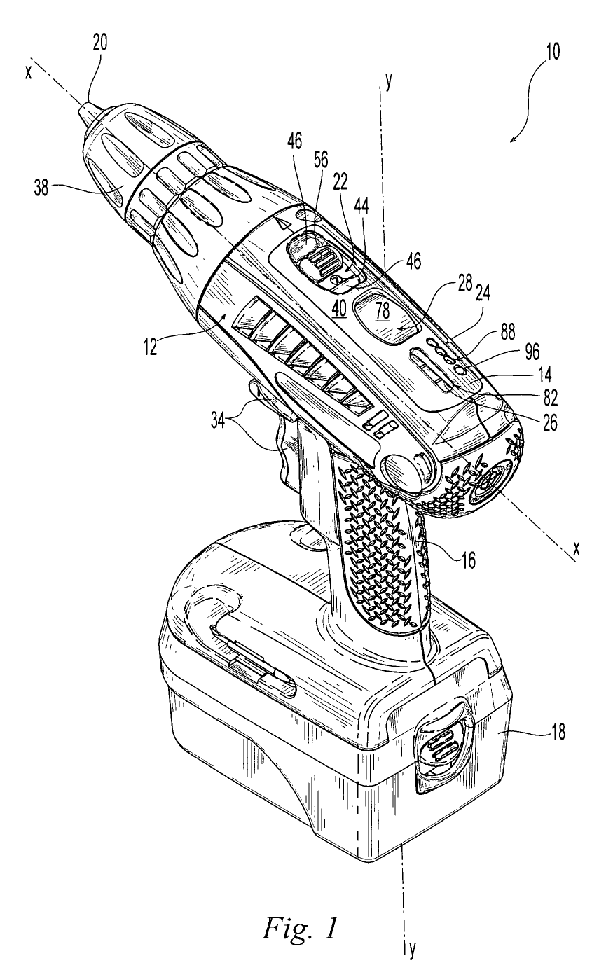

Referring now to the figures, a power tool 10 and power tool body 12 incorporating the example panel 14 is depicted in FIGS. 1-2 and 13-16. The power tool 10 utilized herein for example purposes is a cordless drill. However, other types of power tools may utilize the example panel 14 and features described herein, without limitation. Each power tool 10 typically will include a main body 12, a handle 16, a power supply 18, and an output mechanism 20, as known by those of skill in the art. The main body 12 and handle 16 may be integrally formed or separately formed. In the case of a drill, a circular saw, a router, and a polisher, the output mechanism is a rotary shaft. In the case of a reciprocating saw, the output mechanism is a reciprocating member. In the case of a nailer, the output mechanism is a drive member. While the below description is in the context of the depicted drill 10, those of skill in the art will recognize that the principles described herein are applicable to other types of power tools.

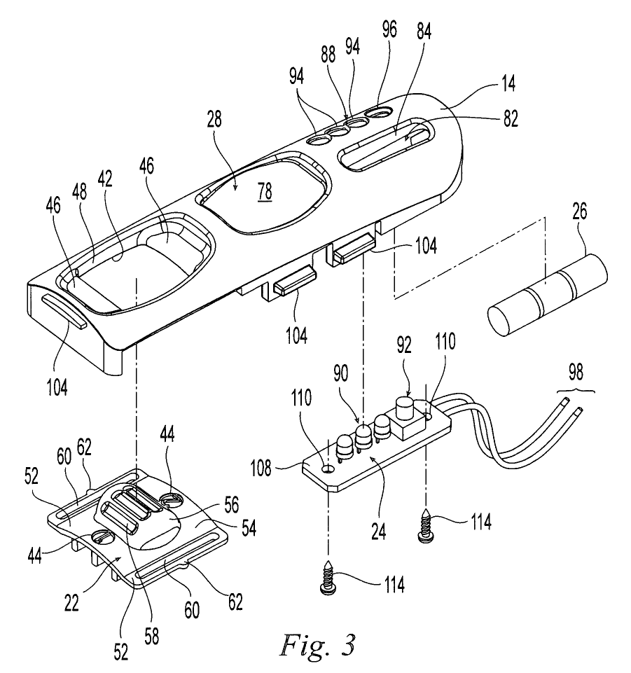

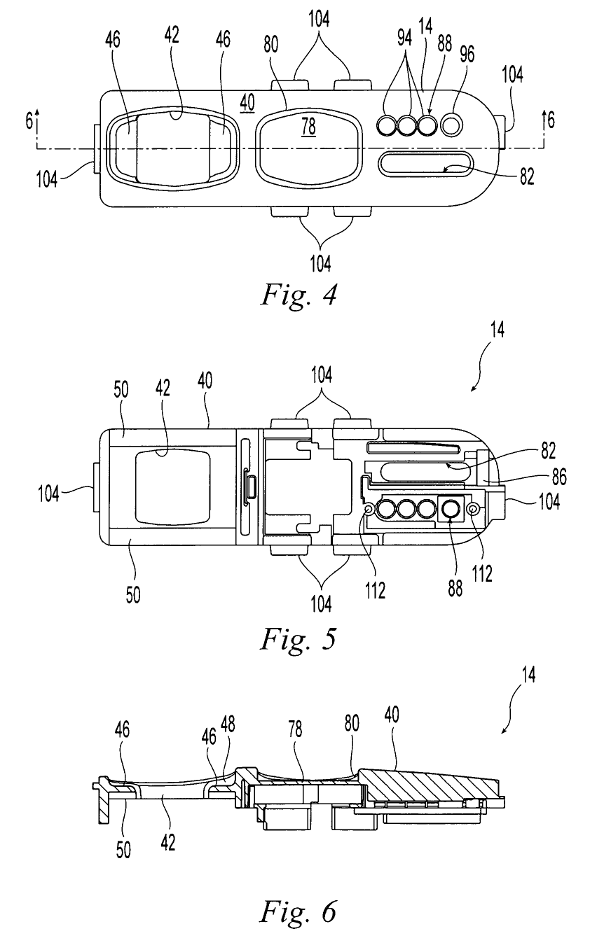

An example panel 14 is depicted in FIGS. 3-12, showing the panel 14 with various accessory components coupled to the panel 14. Example accessory components that are depicted include a gear control switch 22, a power level indicator 24, a bubble level 26, and a magnetic tray 28. Other accessories may also be utilized, such as a snap fitting for holding drill bits and drive bits, a power switch, or other accessories as known by those of skill in the art.

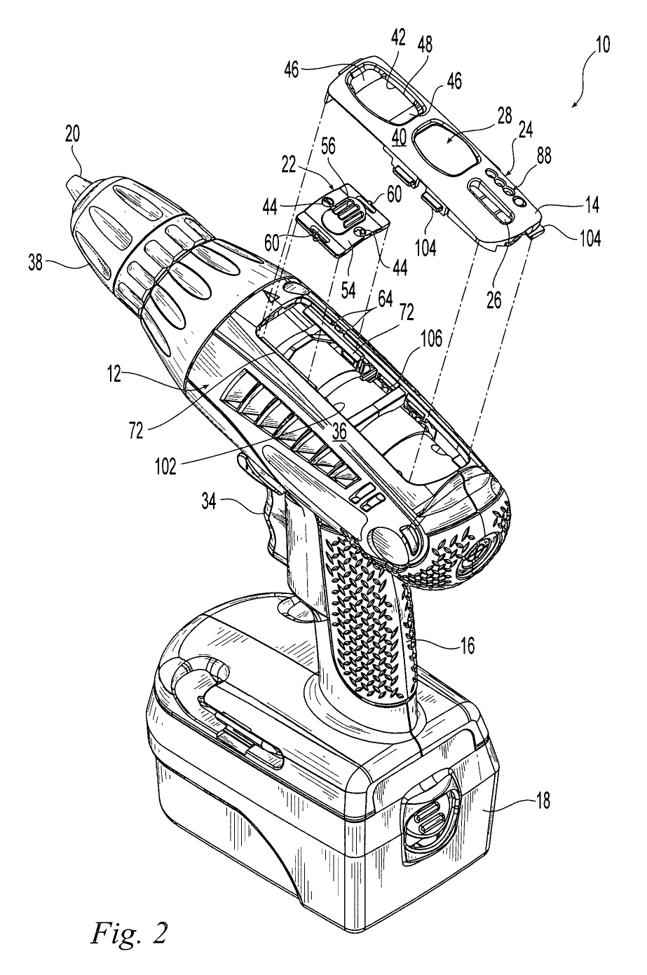

Referring to FIGS. 1 and 2, a power tool 10 in the form of a drill is depicted that utilizes an example panel 14 having a power level indicator 24 in the form of a battery charge indicator. The drill 10 includes a main body 12 that accommodates a drive mechanism 30 and motor 32, and an output mechanism 20 in the form of a rotary output shaft. The drive mechanism 30, motor 32, and rotary output shaft 20 are aligned along a tool axis X-X, although in other embodiments they are not aligned.

The drill 10 includes a handle portion 16 for gripping the power tool 10 and for directing a tool end toward a workpiece. The handle portion 16 is coupled to the main body 12 and is aligned along a handle axis Y-Y. The tool axis X-X is approximately perpendicular to the handle axis Y-Y, but may be positioned at other angles. A motor activation switch 34 is disposed on the handle portion 16 in the example, but other embodiments may have the activation switch 34 positioned in the vicinity of the handle portion 16. The motor activation switch 34 is for activating the drive mechanism 30 and motor 32. When activated, the drive mechanism 30 and motor 34 rotate the rotary output shaft 20, allowing a user to drill 10 into a surface or drive a screw, for example.

The drill 10 depicted is cordless and utilizes a battery or battery pack 18 that is coupled to a lower end of the drill 10. In the embodiment depicted, the battery pack 18 is connected to the handle portion 16 at its lower end. The battery pack 18 provides electrical power to activate the drive mechanism 20 and operate the motor 32. The power drill 10 may also be a corded power drill (not shown) that utilizes AC power via a plug that is configured to plug into an electrical outlet.

An example panel 14, also referred to as a “control panel”, is disposed on the upper surface 36 of the main body 12 of the drill 10. The example control panel 14 has a generally rectangular shape but may be configured in any shape. Alternative control panels may include some or all of these accessories.

In operation, a tool such as a drill bit or similar device is coupled to the rotary output shaft 20 for working on a workpiece. The tool is removably coupled to the rotary output shaft 20 using a chuck 38 or other coupling mechanism. The chuck 38 may be keyless or require a key (not shown) to open and close the chuck. Common tasks performed by the tool and drill 10 include, for example, forming holes and driving fasteners on and into the workpiece.

As shown in FIGS. 3-12, the panel 14 includes a shell 40 having a plurality of openings 42, 82, 88 for receiving the various accessory components. The shell 40 is aligned along the tool axis X-X, although other orientations are possible. The openings 42, 82, 88 are configured for attachment to the various accessories utilizing a coupling mechanism, which will be discussed in greater detail below. FIG. 3 depicts accessories in the form of a gear control switch 22, a magnetic tray 28, a power level indicator 24, and a bubble level 26. The openings 42, 82, 88 in the shell 40 are sized to accommodate the accessories so that they are visible and/or actuatable by a user.

At one end of the shell 40, a first opening 42 is provided for receiving the gear control switch 22. The gear control switch 22 is a slidable switch that allows the user to select the gear, which corresponds to a speed and accompanying torque, for the power tool 10. In particular, the gear control switch 22 alters, through a transmission mechanism 30, the speed and torque of the output mechanism 20 of the power tool 10. In the depicted embodiment, two levels of speed/torque are provided and the user can determine which speed has been selected based upon graphic labels 44 “1” and “2”, which are shown in FIG. 3 as being positioned on the switch 22. The shell 40 has end surfaces 46 that are positioned at the longitudinal ends of the first opening 42. The end surfaces 46 hide one of the labels 44 depending upon the position of the switch 22. Other types or positions of labels may be utilized. In addition, more than two speed/torque levels may be provided, if so desired.

The first opening 42 on the shell 40 is surrounded by vertical side walls 48 and the end surfaces 46, discussed above. The vertical side walls 48 are positioned transversely relative to the longitudinal axis of the shell 40 and the end surfaces 46 extend across each end of the first opening 42. The end surfaces 46 are formed as substantially flat shelves that extend substantially horizontally over the first opening 42 to limit the size of the first opening 42 to hide one of the labels 44 during operation.

Referring to FIG. 5, which depicts the underside of the panel 14, and FIG. 6, which depicts a cross-sectional view of the panel 14, two lower surfaces 50 extend longitudinally along the outer walls on the underside of the panel 14. These surfaces 50 extend longitudinally, and, in this embodiment, are parallel to the main body axis X-X. These surfaces 50 are utilized to mate with the upper surface of side rails 52 of the gear control switch 22 such that the gear control switch 22 moves along these surfaces 50.

As shown in FIGS. 3, 7, 8, 11, and 12, the gear control switch 22 includes a substantially flat body member 54 and a transmission activation member 56. In the example shown, the transmission activation member 56 has a half-dome shape and includes ridges 58 on its upper surface to provide a comfortable grip for the operator's finger. The user operates the transmission activation member 56 by positioning the user's finger on the ridges 58 of the dome and sliding the dome longitudinally either backwards or forwards along the main body axis X-X. Alternatively, the activation member 56 may have any other configuration known in the art. The body member 54 includes two elongated slots 60 and two protrusions 62 on opposite sides of the body member 54. The slots 60 are designed to allow the sides of the member 54 to bend inwardly when force is applied by the protrusions 62 as they slide along the inside of the main body 12. In particular, the protrusions 62 work along with detents 64 that are formed on the main body 12, as shown in FIG. 18, to provide tactile and/or audible feedback to a user as the user moves the transmission activation member 56. The protrusions 62 are configured to slip in and out of the detents 64 as the switch 22 is moved longitudinally, providing a positive “snap” when the switch 22 goes into either the first or second position 64. The detents may alternatively be positioned on the gear control switch 22 with corresponding protrusions positioned on the main body 12.

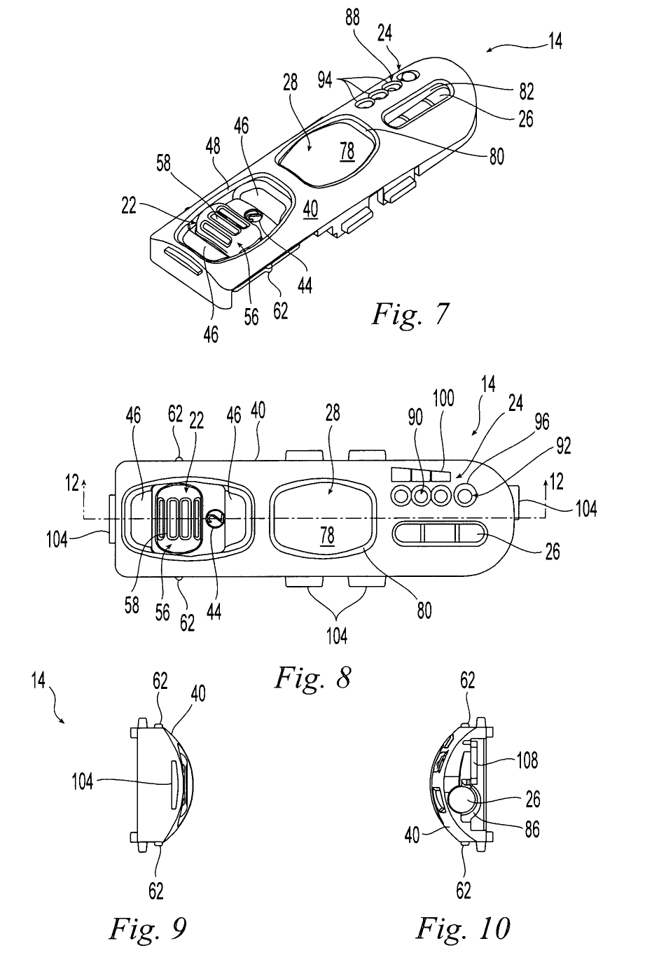

On the undersurface of the gear control switch 22, two “E” shaped ridges 66, shown best in FIG. 7, are provided. A slot 68 is formed between the two “E” shaped ridges 66. The “E” shaped ridges 66 provide stability to the gear control switch 22 and also provide a connection point for the gear control swing arm 70, which is utilized to couple the switch to the transmission or drive mechanism 30 of the power tool 10. The gear control swing arm 70 may include a narrowed or other portion (not shown) configured to mate with the slot 68 between the “E” shaped ridges 66.

FIGS. 7-12 show the gear control switch 22 fitted within the shell 40 in its final position. In this position, the transmission activation member 56 protrudes through the first opening 42, allowing for movement of the switch 22 by a user. The end surfaces 46 around the gear control switch 22 provide extra space for the operator's finger to slide the transmission activation member 56.

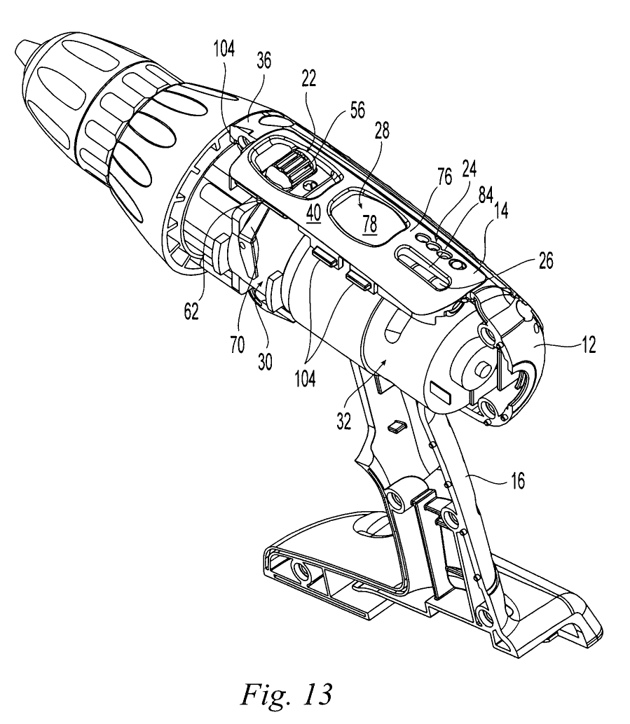

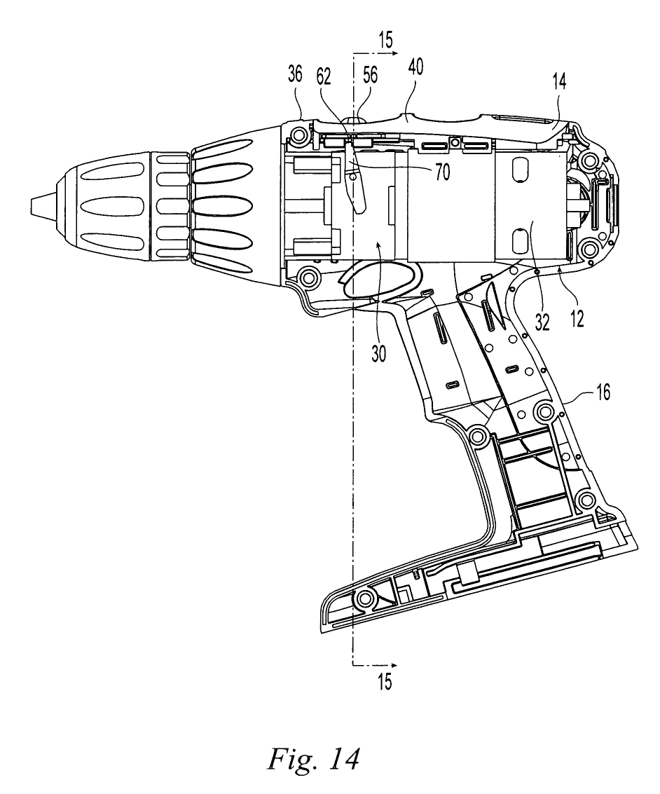

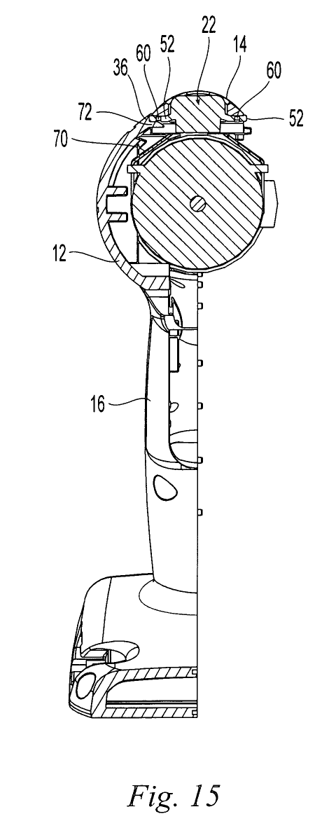

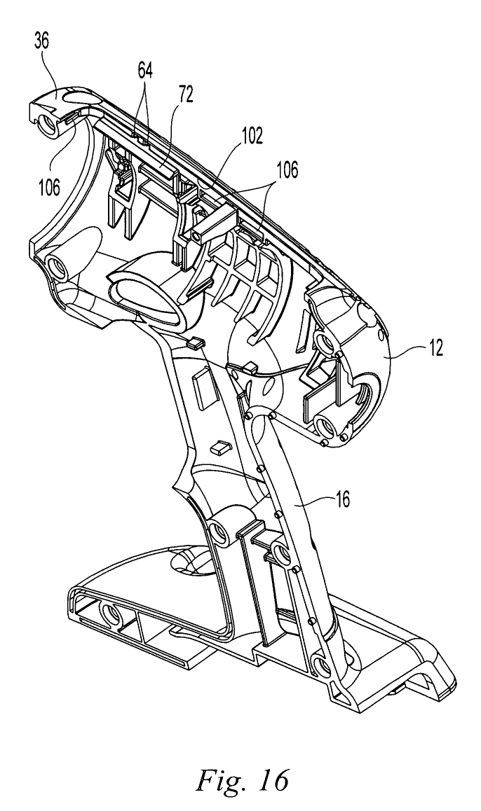

FIGS. 13-16 illustrate how the gear control switch 22 seats on the main body 12. As shown in FIGS. 15 and 16, the main body 12 includes two ledges 72, one on either side of the main body 12 in the vicinity of the gear control switch 22. The side rails 52 of the gear control switch 22 seat on these ledges 72 and are slideable along the ledges 72. As shown in FIGS. 13-14, the gear box swing arm 70 is located on one side of the drill main body 12. The gear control swing arm 70 is coupled to the gear control switch 22 at one end and to the power tool's transmission 30 at its other end. When the transmission activation member 56 is moved by a user's finger, the gear control swing arm 70 moves simultaneously, thereby moving the swing arm 70 between the two transmission speeds. It should be noted that other types of gear control switches may be utilized with the example control panel 14.

To assemble the gear control switch 22 onto the power tool 10, the switch 22 is positioned on the gear control swing arm 70 so that the upper end of the swing arm is positioned in the slot 68 between the “E” shaped ridges 66 of the switch 22. The switch side rails 52 are positioned on the ledges 72 of the main body 12, and the control panel 14 is positioned over the switch 22 and snapped into place. In the installed position, the switch side rails 52 are sandwiched between the ledges 72 of the main body 12 and the underside side surfaces 50 of the control panel 14. The gear control switch 22 is generally free to slide longitudinally, but is deterred from moving transversely.

A discussed above, the side rails 52 of the gear control switch 22 include transversely extending protrusions 62 on either side of the switch 22. These protrusions 62 are configured to mate with detents 64 defined in the main body 12 to provide the user with tactile and/or audible information concerning the position of the switch 22. Two detents 64 are provided on both sides of the main body 12 in close proximity to one another, as shown in FIG. 16. The protrusions 62 are positioned on the side rails 52 so that they mate with the detents 64. When the protrusions 62 are positioned in the forward detents, the power tool 10 is operable at a first speed and torque. When the protrusions 62 are positioned in the rearward detents, the power tool 10 is operable at a second speed and torque. The protrusions 62 and detents 64 are utilized to hold the switch 22 in a particular position until the user desires to move the switch 22 to the other position.

The gear control switch 22 is utilized to switch the power tool 10 from one speed and torque to another. The gear control swing arm 70 is coupled to a ring gear (not shown) that is positioned inside the transmission gearbox. As the gear control switch 22 is moved back and forth between the first position and the second position, the gear box is moved between a “locked” position and a “free” position. The “locked” position corresponds to position “1” and the “free” position corresponds to position “2” of the switch. When the ring gear is in the “locked” position, it is prevented from rotating inside the gearbox. This lowers the gear ratio, decreasing the speed but increasing the torque of the motor. This “locked” position is useful for such things as inserting screws, but may be used for any number of other operations. In contrast, when the ring gear is in the “free” position, the ring gear is allowed to rotate freely inside the gearbox, effectively lowering the gear ratio. This increases the speed but decreases the torque and corresponds to position “2” of the switch. The high speed/low torque position “2” is normally used for drilling holes, but may be used for other applications, as appropriate.

Returning to FIGS. 3 and 7-12, the control panel shell 40 also accommodates a recessed magnetic tray 28. In the depicted embodiment, the tray 28 is insert molded into the material of the shell 40 so that the magnet 74 is recessed beneath the upper surface 76 of the control panel 14. The outer surface of the tray includes a base 78 and a vertical sidewall 80 that extends around the base 78 and connects the base 78 to the upper surface 76 of the shell 40. As shown in FIG. 12, the magnet 74 is integrally molded into the shell 40 and positioned beneath the base 78. The magnet 74 has a strength that is capable of retaining metallic objects, such as screws or drill bits, on the magnetic tray 28. Instead of being integrally molded within the shell 40, one or more magnetic elements may be attached over or under the base to provide the required magnetic force, if so desired.

The shell 40 also includes a second opening 82 for receiving a bubble level 26. The bubble level 26 measures the relative inclination of the drill 10 with respect to the ground and helps the operator orient the main body axis X-X of the power drill 10 parallel with the ground during operation. More than one bubble level 26 may be provided in order to show inclination of the drill 10 in more than one direction. The second opening 82 is sized and shaped to allow the user to view the level 26 when the level 26 is installed in the panel 14. The second opening 82 is elongated and has vertical side walls 84 that project downwardly in a cylindrical manner from the upper surface of the shell 40. The bubble level 26 is retained in the control panel 14 via a retaining arm 86, shown best in FIG. 10. The retaining arm 86 has a shape to accommodate the bubble level 26 and hold it in position. Once the control panel 14 is installed in the power tool main body 12, the bubble level 26 may be further retained from movement by parts within the main body 12 or by the main body 12 itself.

The shell 40 also includes a third opening 88 that is positioned beside the level 26 for receiving the visible parts of a power level indicator 24. The power level indicator 24 is electrically coupled with the power source 18 of the power tool 10. In the case where a battery 18 is used as the power source 18, the power indicator 24 is a battery charge indicator. The third opening 88 is sized and shaped to accommodate the power indicator 24 so that it is visible to the user of the power tool 10. The type of power indicator 24 depicted herein includes an illumination mechanism 90 comprising three light emitting diodes (LEDs), and a battery charge indicator activation mechanism 92 comprising a compressible button that operates a switch (not shown) when depressed. In the depicted embodiment, the battery charge activation button 92 is black in color, but may be any color desired. Any combination of a battery charge activation mechanism 92 and illumination mechanism 90 may be used for this purpose, the example control panel 14 not being limited to the number of LEDs depicted or the type of power indicator depicted. Instead of using three individual LEDs, a single indicator could be used that emits a different color depending on the charge level. A bar-type scale could be used where a portion of the bar lights up based upon the charge level. Alternatively, a mechanical power level indicator or other types or configurations of power level indicating devices may be utilized without departing from the claimed example.

In operation, to determine the power level of the power source 18, the user presses the button 92 when information concerning power level of the power source 18 is needed. When the button 92 is pressed, the LEDs 90 illuminate to indicate whether the power source 18 is fully charged, charged at some intermediate power level, or experiencing a low charge level. Other embodiments may not utilize a button 92 to indicate power and power indication may be constant, if desired, or intermittent depending upon whether the power tool 10 is in operation. Other types of battery charge activation mechanisms may be utilized, if desired.

As shown in FIGS. 1-5, 7-8, and 13, the third opening 88 includes three apertures 94 that are positioned adjacent one another to accommodate the three LEDs. Since the LEDs that are shown are circular, the apertures 94 in the example panel 14 are depicted as being circular. Other shapes of apertures, or a single, elongated aperture may be utilized. A fourth aperture 96 is positioned in proximity to the LEDs 90 corresponding to the battery charge activation mechanism 92 in the form of a button that is depressible. While the depicted embodiment includes the battery charge activation mechanism 92 positioned directly adjacent the illumination mechanism 90, it may be desirable in other embodiments to position the battery charge activation mechanism 92 at another location on the main body 12 or handle 16, or elsewhere on the housing, such as closer to the motor activation switch 34.

As shown in FIG. 3, a pair of electrical contact leads 98 having opposite electrical polarity provide the electrical connection between the battery charge indicator 24 and the battery 18. The battery charge indicator 24 is fixed to the shell 40 so that when it is in its final position, the three LEDs 90 and the button 92 protrude through the apertures 94, 96, respectively. When the operator presses the battery charge activation switch 92, the electrical contact leads 98 communicate electrical power to operate the LEDs 90, which, in turn, illuminate according to the amount of power remaining in the battery pack 18. Thus, when the battery pack 18 is fully charged, all three LEDs will illuminate, when the battery charge level is at an intermediate level, two LEDs will illuminate, and when the battery charge level is low, only one LED will be illuminated, indicating to the operator that the battery pack 18 needs re-charging. In the example panel 14, the upper surface 76 of the shell 40 may include stamp art 100 or other indicia next to the LEDs 90 in order to indicate charge level. The stamp art 100 shown has the letters F, for full, and E, for empty, to help the operator interpret the meaning of the illuminated LEDs 90. The stamp art 100 also includes a scale that is wider at the “full” end and narrower at the “empty” end. Other types of art or graphics may be utilized to indicate the charge level of the battery pack 18. Alternatively, the graphics may be eliminated all together. In addition, other techniques for illuminating the LEDs may be utilized. For example, a single LED could be illuminated depending on the charge level. In this example, the LED closest to the “full” indicator would illuminate when the battery 18 is fully charged, the LED closest to the “empty” indicator would illuminate when the battery 18 is nearly empty, and the center LED would illuminate when the battery 18 is only partially charged.

There are several advantages to having a battery charge indicator 24 on the upper surface 36 of a power tool 10. For example, such an arrangement provides easy visibility regardless of the handedness of the operator, and easy accessibility in that there is no need to rotate the power tool 10 to view the battery charge indicator 24. Viewing a battery charge indicator 24 on top of a power tool 10 is also more comfortable because the natural position for a person's wrist will usually have the top of the power tool 10 facing towards the operator's eyes.

Positioning the battery charge indicator 24 on the upper surface of the power tool 10, rather than on the battery pack 18, is also desirable from a durability point of view. When a power tool 10 is accidentally dropped, it will often land on the battery pack 18, which is the heaviest part of the tool. Such a drop can damage any electrical parts that are positioned on the battery pack 18. There are also cost cutting benefits to putting the battery charge indicator 24 on the body 12 of the power tool 10, as opposed to on the battery pack 18, because user's typically purchase multiple battery packs for their power tools. By positioning the battery charge indicator 24 on the drill 10 itself, the battery packs 18 can be manufactured less expensively because they no longer need a battery indicator.

The example panel 14 provides modularity during the manufacturing process because the accessory components may be coupled to a single sub-assembly prior to insertion of the panel 14 into the main body opening 102. This provides for ease of manufacture. As shown in FIGS. 2 and 7-10, the panel 14 includes a plurality of lugs or protrusions 104 that extend outwardly from the side edges of the panel 14. The opening 102 in the main body 12 includes mating recesses 106 for accepting the protrusions 104. Once the panel 14 is assembled, the panel 14 may be snapped into position on the body 12. This provides a number of benefits. For example, if the panel 14 is broken, the panel 14 may be easily replaced without having to completely disassemble the power tool 10. In addition, a single panel 14 may be utilized on a variety of power tools. Further, the manufacturing process is made easier because the accessories are installed on the panel 14 rather than having to install the accessories into individual openings that are defined on the power tool main body 12.

The accessory components are coupled to the panel 14 utilizing coupling mechanisms. In the case of the bubble level 26, as shown best in FIG. 10, a cylindrical cavity 84 is formed on the underside of the panel 14 and a curved arm 86 extends downwardly from the panel 14 and has a shape substantially the same as the bubble level 26. The bubble level 26 is slid into the opening provided by the arm 86 during assembly of the panel 14. The bubble level 26 is prevented from slipping out of the end of its cylindrical cavity by the end of the cavity at an end opposite the arm 86. The cylindrical cavity keeps the level 26 from shifting from side-to-side or up and down once assembled in position.

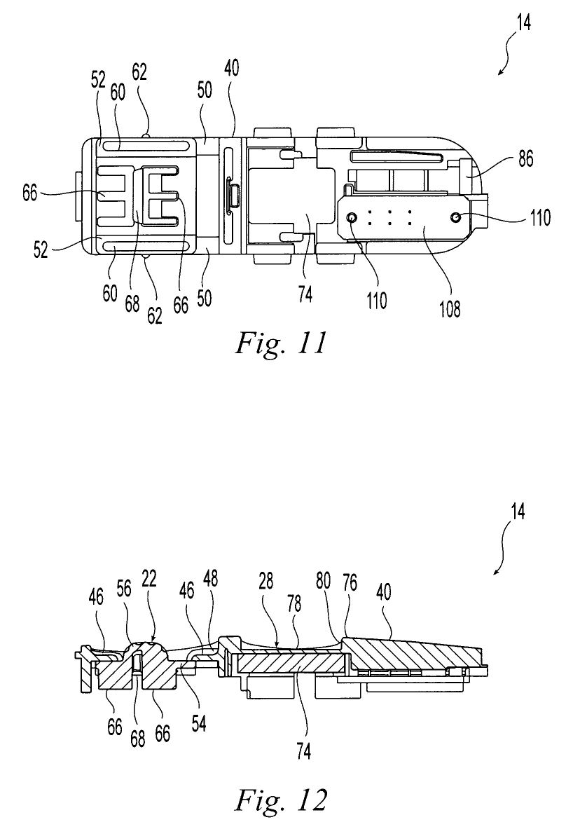

The battery charge indicator 24, in the depicted embodiment of FIGS. 3 and 11, includes a circuit board or other board-like member 108, with the LEDs 90 and battery charge activation button 92 positioned on the board 108. The board 108 includes two screw holes 110 and the underside of the panel 14 includes two screw holes 112. When the board 108 is positioned on the underside of the panel 14 such that the LEDs 90 and battery charge activation button 92 extend through the appropriate openings, the screw holes 110 on the board 108 align with the screw holes 112 on the underside of the panel 14. When a screw 114 is inserted through the holes 110, 112, the battery charge indicator 24 is connected to the panel 14. Electrical leads 98 from the battery charge indicator 24 extend from the board 108. Prior to installation of the panel 14 to the main body 12, the electrical leads 98 can be coupled to an electrical fitting (not shown) or to other wires via a connector (not shown), the example panel 14 not being limited to or concerned with the type of connector or fitting utilized to couple the battery charge indicator 24 to the battery 18. The battery charge indicator 24 may be coupled to the panel 14 in any known way. For example, it is envisioned that the indicator 24 could be coupled without the need for screws.

The magnet 74, in the depicted embodiment, is insert molded into the panel 14 during manufacture of the panel 14. The panel 14 itself serves as the coupling mechanism when the magnet 74 is insert molded. This is shown best in FIG. 12. The magnet 74 is positioned under the outwardly facing surface 78 of the tray 28. Alternatively, the magnet 74 can be positioned on the panel 14 with fasteners or via another coupling mechanism. The magnet 74 could be exposed to the exterior, instead of being positioned under the plastic layer 78.

The gear control switch 22 is not permanently coupled to the panel 14 prior to insertion of the panel 14 into the main body 12, in the depicted embodiment. As discussed above, the gear control switch 22 is coupled to the gear control swing arm 70 and positioned so that the side rails 52 of the switch 22 ride on ledges 72 disposed on the main body 12. The panel 14 is positioned over the gear control switch 22 and maintains the switch 22 in movable position on the main body 12. Other types of gear control switches may be utilized with the example panel 14. For example, a gear control switch could be coupled to the panel 14 prior to insertion of the panel 14 on the main body 12.

The main body 12, motor 32, handle 16, output mechanism 20, and battery pack 18 of the power tool 10 may be manufactured in any known way. In one embodiment, the control panel 14 is made of acrylonitrile butadiene styrene (“ABS”) (UL approved) and is manufactured using an injection molding process, as known by those of skill in the art.

The term substantially is used herein as an estimation term.

While various features of the claimed embodiments are presented above, it should be understood that the features may be used singly or in any combination thereof. Therefore, the claimed embodiments are not to be limited to only the specific embodiments depicted herein.

Further, it should be understood that variations and modifications may occur to those skilled in the art to which the claimed embodiments pertains. The embodiments described herein are exemplary. The disclosure may enable those skilled in the art to make and use embodiments having alternative elements that likewise correspond to the elements recited in the claims. The intended scope may thus include other embodiments that do not differ or that insubstantially differ from the literal language of the claims. The scope of the example embodiments is accordingly defined as set forth in the appended claims.

What is claimed is:

1. A handheld power tool comprising:
a main body having an upper surface and including a drive mechanism, a motor, and an output mechanism, said motor being coupled to a power source;
a handle portion coupled to the main body and having a motor activation switch associated therewith, said motor activation switch being coupled to the motor in order to activate the output mechanism; and
a power level indicator positioned on the upper surface of the main body.

2. The tool of claim 1, wherein the power source is a battery and the battery is coupled to the main body and in association with the motor, wherein the power level indicator is a battery charge indicator that is electrically coupled to the battery.

3. The tool of claim 2, where the battery is removably coupled to the handle portion and the battery indicator comprises at least one LED.

4. The tool of claim 1, further comprising a panel coupled to an opening in the upper surface of the main body, wherein the power level indicator is coupled to the panel.

5. The tool of claim 4, wherein the panel is configured to accept at least one accessory component selected from the group consisting of a gear control switch, a magnet, a part holder, a level, a tray, and a power level indicator.

6. The tool of claim 5, wherein the magnet comprises a molded-in magnet, with the magnet being associated with a tray, and the level is a bubble level.

7. The tool of claim 4, wherein the panel comprises a gear control switch for controlling the output of the power tool, a magnet for retaining metallic objects, a level, and the power level indicator.

8. The tool of claim 1, wherein the power level indicator comprises an illumination mechanism and a power level activation mechanism.

9. The tool of claim 4, wherein the panel comprises a plurality of protrusions and the main body comprises a plurality of recesses, and the protrusions and recesses are configured to mate with one another to join the panel to the main body.

10. The tool of claim 5, wherein the gear control switch is coupled to the panel and includes first and second side rails, the main body includes first and second ledges that are configured to hold the first and second side rails of the gear control switch, the panel includes an opening through which at least part of the gear control switch is accessible for movement by a user, and the first and second side rails of the gear control switch are sandwiched between the panel and the first and second ledges on the main body to allow movement of the gear control switch relative to the main body and panel when the panel is installed on the main body.

11. The tool of claim 10, wherein each of the first and second side rails include laterally extending protrusions, and the main body comprises at least one detent adjacent each of the first and second ledges for mating with the protrusions, wherein movement of the gear control switch results in movement of the protrusions in and out of contact with the at least one detent to provide at least one of a tactile or audible signal to the user indicating that the gear control switch is associated with a particular gear of the drive mechanism.

12. The tool of claim 4, wherein the panel is modular in that it is configured to allow coupling of at least one accessory component to the panel prior to installation of the panel in the opening on the main body.

13. A power tool comprising:
a main body having an upper surface;
a handle portion;
a battery coupled to one of the main body or the handle portion; and
a battery charge indicator disposed on said upper surface of said main body and electrically coupled to the battery.

14. The power tool of claim 13, wherein the battery charge indicator includes an illumination mechanism and a battery charge activation mechanism.

15. The power tool of claim 13, wherein the battery charge indicator is disposed on a panel member that is coupled to an upper surface of the power tool.

16. A modular panel for a power tool configured to seat in an opening disposed in a power tool comprising:
a panel member configured to couple to a housing of a power tool;
at least one opening disposed on the panel member for association with an accessory component; and
at least one coupling mechanism associated with the panel member for coupling an accessory component to the panel member, wherein the coupling mechanism is configured to allow coupling of the accessory component to the panel member prior to coupling of the panel member with a housing of a power tool, and the at least one opening in the panel is provided to allow access to the accessory component by a user.

17. The modular panel of claim 16, wherein the at least one opening in the panel member comprises a plurality of openings and the at least one accessory component comprises a plurality of accessory components.

18. The modular panel of claim 16, wherein the plurality of at least one accessory component includes one or more of a gear control switch, a magnetic tray, a level, and a power level indicator.

19. A method for manufacturing a power tool comprising:
providing a housing of a power tool, said housing having an opening defined therein;
providing a panel member that is configured to couple to the opening in the housing, said panel member having a plurality of panel openings disposed for association with accessory components and a plurality of coupling mechanisms for coupling the accessory components to the panel member, said plurality of accessory components including one or more of a gear control switch, a magnetic tray, a level, and a power level indicator;
coupling a plurality of accessory components to the openings in the panel member utilizing the coupling components; and
coupling the panel member to the housing of the power tool.
